(19) United States
(12) Patent Application Publication
(10) Pub. No.: US 2022/0334037 A1
(43) Pub. Date: Oct. 20, 2022

(54) SCANNING SYSTEM AND METHOD FOR SCANNING VESSELS

(71) Applicant: JOHNSON MATTHEY PUBLIC LIMITED COMPANY, London (US)

(72) Inventors: Owen John Lloyd JONES, Billingham, Cleveland (GB); Carl Robert TIPTON, Billingham, Cleveland (GB); Victoria WHITTLE, Billingham, Cleveland (GB)

(21) Appl. No.: 17/753,459

(22) PCT Filed: Sep. 4, 2020
(86) PCT No.: PCT/GB2020/052114

§ 371 Date: Mar. 3, 2022

(30) Foreign Application Priority Data
Oct. 24, 2019 (GB) 1915412.9

(51) Int. Cl. G01N 9/24; G01N 23/06; G01N 23/046; G05D 1/00

(52) U.S. Cl. CPC G01N 9/24; G01N 23/06; G01N 23/046; G05D 1/0094; G01N 2223/316; G01N 2223/04; G01N 2223/419; G01N 2223/33; G05D 2201/0207

(57) ABSTRACT

A method of scanning an industrial chemical vessel to monitor a chemical process within the industrial chemical vessel, the method comprising: positioning a first unmanned aerial vehicle (UAV) carrying a gamma radiation source on one side of the vessel, positioning a second UAV carrying a gamma radiation detector on an opposite side of the vessel, moving the first and second UAVs to scan the vessel by passing gamma radiation through the vessel from the radiation source carried by the first UAV to the radiation detector carried by the second UAV thereby measuring a density profile, identifying a location of one or more fluid layers within the industrial chemical vessel, and determining if a chemical process within the industrial chemical vessel is operating correctly based on the location of the one or more fluid layers within the industrial chemical vessel identified using the first and second UAVs.

### FIELD

The present specification relates to a scanning system and method for scanning vessels, and particularly for scanning vessels which are large, tall and/or located high up in the air. Examples of vessels include industrial chemical vessels such as towers and tanks on industrial chemical sites, e.g. distillation towers, storage tanks, separator vessels, and the like.

### BACKGROUND

It is known to conduct scans of industrial chemical vessels, such as distillation towers on petrochemical sites, using a technique called gamma scanning. In this technique a radioactive isotope emitting gamma radiation and a detector are lowered down two opposing sides of a tower to measure the density inside the tower at various different heights. Gamma radiation is transmitted through the tower from the radioactive source on one side of the tower to the detector on an opposite side of the tower. Attenuation of the gamma radiation as it passes through the tower is dependent on the density of the material through which the radiation passes. As such, a density profile of the tower can be generated, and this can be used to diagnose problems with the tower and/or the process operating in the tower without opening the tower and/or stopping the process. For example, it is possible to identify the location of different fluid layers having different densities in a multi-layer fluid column comprising, for example, layers of solid, aqueous, emulsion, oil, and/or gas phases. For certain chemical processes it is required to maintain a fluid surface or interface at a specific height within a tower. The gamma scanning technique allows the interior of a tower to be interrogated to determine correct operating conditions and/or diagnose a problem in the tower.

Currently gamma scans are performed by lowering a source and a detector down a tower on a winch system. This requires two field engineers to climb the tower and work at height to install and operate the winch system. This also requires the tower to be provided with suitable ladders and access for the field engineers to install and operate the gamma scanning equipment.

As an alternative to using a single radiation source and detector which are moved down the tower in unison to measure a density profile of the tower, an array of radiation sources and detectors can be provided extending down on opposite sides of the tower to provide source/detector pairs at fixed locations down the tower. In order to obtain the required measurement accuracy, such a system adopts a collimated design which ensures that each source/detector pair is focused at a particular elevation. In this way, a density profile of the tower can be generated in a similar fashion to the scanning method. However, this system requires the radiation source and detector arrays to be mounted to the tower which again is labour intensive and involves field engineers working at height.

Such equipment can be installed and operated periodically to monitor a tower, or the equipment may be installed and operated when a problem occurs within a tower which requires diagnosis. As previously indicated, this is labour intensive and involves field engineers working at height. As an alternative, the equipment can be permanently installed on a tower, although this is costly, and the equipment may still need periodic maintenance requiring field engineers to work at height. Furthermore, permanently installing radiation sources at a site may not be feasible from a regulatory or safety perspective.

In addition to the density profile measurements on a tower as outlined above, it is also known to take computed tomography (CT) gamma scanning measurements of a tower. CT gamma scanning involves locating a radiation source on one side of the tower and a detector on the other side of the tower. The source and detector are then moved around the circumference of the tower taking measurement at a plurality of radial directions around the tower. Reconstruction models then take this information and use it to generate an accurate image of the tower at that location. This has the advantage of generating a density map which can provide information about the tower wall thickness and integrity, the product flowing conditions, and the condition of any coating applied to the tower. CT scans can be performed at multiple heights down the tower to build a three-dimensional picture of the tower interior. Such CT gamma scanning techniques are extremely labour intensive and involve field engineers working at height to install and operate the equipment.

It is an aim of the present specification to provide an improved system and method for scanning vessels such as industrial chemical towers.

### SUMMARY OF INVENTION

The present inventors have identified the problems with their existing techniques for scanning tall/large industrial chemical vessels as set out in the background section. In order to address these problems, the present specification provides a system for scanning a vessel, the system comprising:
a first unmanned aerial vehicle (UAV) carrying a radiation source;
a second UAV carrying a radiation detector;
and a controller configured to move the first and second UAVs in a coordinated fashion in order to scan the vessel by passing radiation through the vessel from the radiation source carried by the first UAV to the radiation detector carried by the second UAV.

Such a system takes advantage of developments in UAV (drone) technology in terms of the precision with which UAVs can now be controlled and uses this technology to address the particular problems with existing techniques of scanning tall/large vessels/towers using a radiation source and detector. The advantages of the new system are numerous and include:
Safety: two people do not have to climb a tower and work at height.
Access: towers which do not have ladders and access can be scanned.
CT Scanning: although CT scanning techniques are already used on chemical towers, they are extremely labour intensive and involve much complex working at height. The UAVs can simply rotate around a tower at any height required.
Speed: towers can be scanned more quickly as installation of winch equipment isn't required.
Manpower: towers can be scanned with one field engineer instead of the two currently required.

The system as described herein can be used for scanning a range of different types of vessel but is particularly suited for scanning industrial chemical vessels such as towers and tanks on industrial chemical sites, e.g. distillation towers, storage tanks, separator vessels, and the like. A method of scanning such vessels is provided, the method comprising:
positioning the first UAV on one side of the vessel;
positioning the second UAV on an opposite side of the vessel;
and moving the first and second UAVs in a coordinated fashion in order to scan the vessel by passing radiation through the vessel from the radiation source carried by the first UAV to the radiation detector carried by the second UAV.

In particular, this specification provides a method of scanning an industrial chemical vessel to monitor a chemical process within the industrial chemical vessel, the method comprising:
positioning a first unmanned aerial vehicle (UAV) carrying a gamma radiation source on one side of the vessel;
positioning a second UAV carrying a gamma radiation detector on an opposite side of the vessel;
moving the first and second UAVs in a coordinated fashion in order to scan the vessel by passing gamma radiation through the vessel from the radiation source carried by the first UAV to the radiation detector carried by the second UAV thereby measuring a density profile of the industrial chemical vessel;
identifying a location of one or more fluid layers within the industrial chemical vessel; and
determining if a chemical process within the industrial chemical vessel is operating correctly or if there is a problem with the chemical process within the industrial chemical vessel based on the location of the one or more fluid layers within the industrial chemical vessel identified using the first and second UAVs.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a UAV scanning system performing a density profile scan of a tower; and

FIG. 2 shows a UAV scanning system performing a CT scan of a tower.

### DETAILED DESCRIPTION

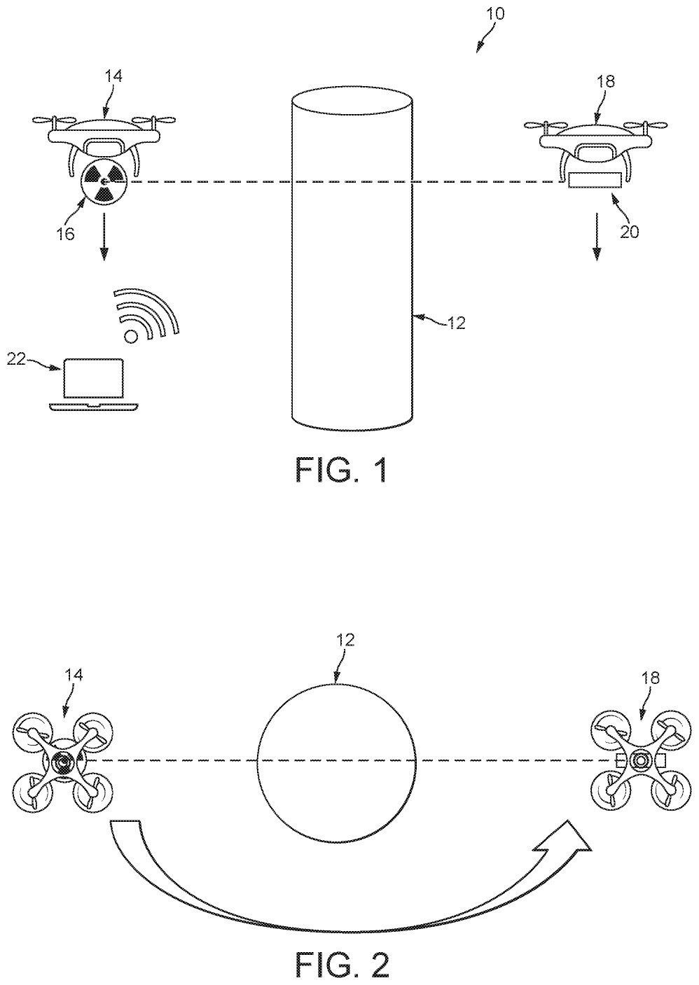

As described in the summary section, and as illustrated in FIG. 1, the present specification provides a system 10 for scanning a vessel 12, the system 10 comprising: a first UAV 14 carrying a radiation source 16; a second UAV 18 carrying a radiation detector 20; and a controller 22 configured to move the first and second UAVs 14, 18 in a coordinated fashion in order to scan the vessel 12 by passing radiation through the vessel 12 from the radiation source 16 carried by the first UAV 14 to the radiation detector 20 carried by the second UAV 18.

The controller is configured to maintain a fixed distance between the first and second UAV as the vessel is being scanned. The attenuation of radiation between the source and detector is dependent on the distance between the source and the detector in addition to the density of the materials through which the radiation passes. As such, by configuring the controller to maintain a fixed distance between the UAVs then variations in the radiation data resulting from variations in path length are reduced or eliminated. As an alternative, or in addition, the system can be configured to correct the radiation data for variations in path length between the UAVs during scanning by using location data from the UAVs to detect and account for any variations in path length.

The method of scanning a vessel comprises: positioning the first UAV on one side of the vessel; positioning the second UAV on an opposite side of the vessel; and moving the first and second UAVs in a coordinated fashion in order to scan the vessel by passing radiation through the vessel from the radiation source carried by the first UAV to the radiation detector carried by the second UAV. The way in which the UAVs are moved, and the number and location of the radiation measurements taken, can be varied according to the type of scanning which is to be performed. A computer can be used to control both UAVs, executing a pre-defined flight plan and ensuring the UAVs stay synchronized in terms of height and positioning relative to each other. Software already exists for planning and executing UAV flights. In the present system, the fight plans should be designed and synchronized with the control of radiation measurements to implement a desired scanning method. Two different scanning methods are illustrated in FIGS. 1 and 2 as discussed below.

In the arrangement shown in FIG. 1, the controller 22 is configured to locate the first UAV 14 on one side of the vessel 12 and the second UAV 18 on an opposite side of the vessel 12 and move both the first and second UAVs 14, 18 along (down) the vessel 12 in a coordinated fashion in order to generate a density profile of the vessel 12. In this case, the first and second UAVs are positioned at the same height to take a measurement and then moved down to a second height to take a further measurement and so on. In this way, the density profile of the vessel can be mapped. This may be used, for example, to measure the height of a liquid in the vessel or the location of layers and interfaces in a multi-layered column comprising, for example, solid, aqueous, emulsion, oil, and gas phases.

In the arrangement shown in FIG. 2, the controller is configured to locate the first UAV 14 on one side of the vessel 12 and the second UAV 18 on an opposite side of the vessel 12 and to move both the first and second UAVs 14, 18 around the vessel 12 in a coordinated fashion in order to generate a computed tomography (CT) scan of the vessel 12. In this case, the UAVs move around the circumference of the tower taking measurement at a plurality of radial directions around the tower. Reconstruction models then take this information and use it to generate an accurate image of the tower at that location. This has the advantage of generating a density map which can provide information about the tower wall thickness and integrity, the product flowing conditions, and the condition of any coating applied to the tower. CT scans can be performed at multiple heights down the tower to build a three-dimensional picture of the tower interior. Such CT gamma scanning techniques have previously been extremely labour intensive. The UAV system described here is highly advantageous for such scanning.

Each of the first and second UAVs comprises one or more sensors for measuring and controlling the UAV's distance from the vessel and/or height from the ground. Suitable sensors include LIDAR sensors (light detection and ranging), laser range finders, and altimeters to measure and control the UAVs distance from the tower and height from the ground. The sensors can be used to correct the path length between the two UAVs and to monitor the height of the UAVs such that height data can be synchronized with radiation data to produce a density profile of the tower.

The radiation source can be an ionizing radiation source such as a gamma radiation source, e.g. Cs-137. An X-ray generator could also be used to generate the radiation. The radiation source carried by the first UAV can be disposed in a housing which at least partially shields the radiation source from its surroundings. The housing can further include a collimator in order to direct a beam of radiation from the radiation source towards the radiation detector carried by the second UAV. In this case, the controller is configured to orientate the first UAV to direct the beam of radiation towards the radiation detector carried by the second UAV as the vessel is being scanned.

As a safety measure, the housing can also be configured to have a shutter for completely sealing the radiation source within the housing, and the system may further comprise a safety shut off such that in the event of a system malfunction the shutter is closed to completely seal the radiation source within the housing. The UAV carrying the radiation source, or indeed both UAVs, can also be provided with a tether such that the UAVs are tethered to the ground and cannot fly beyond a range defined by the length of the tether. A shielding container can also be provided for housing the UAV which carries the radiation source. As such, the UAV can be deployed from the shielding container to minimise human interaction with the source.

The system further comprises a data processor for processing radiation data from the detector. In practice the controller and the data processor can be provided in the same computer unit 22 illustrated in the Figures, which may be a laptop, tablet, smart phone, or other mobile computing device. However, this is not necessarily the case and it is envisaged that the controller and data processing unit could be provided in separate devices.

The radiation detector comprises a data link for transmitting radiation data to the data processor. The radiation detector carried by the second UAV can be battery operated and capable of transmitting data wirelessly. One or both of the first and second UAVs can also be provided with a data link (e.g. a wireless data link) for transmitting location data to the data processor. It is also possible to use the same data link for transmitting both the radiation data and the UAV location data. The data processor is configured to synchronize the radiation data and location data to generate a scan profile.

While the system as illustrated in FIGS. 1 and 2 includes a single UAV carrying a radiation source and a single UAV carrying a radiation detector, systems as described herein are not limited to this configuration. The system may comprise more than one UAV carrying a radiation source and/or more than one UAV carrying a radiation detector. The controller is configured to move all the UAVs in a coordinated fashion in order to scan the vessel by passing radiation through the vessel from the radiation sources to the radiation detectors. In this case, the UAVs can be configured into source-detector pairs to performing the scanning. Using multiple drones can be used to increase the speed at which complex scanning techniques, such as CT scanning, can be performed.

Using the aforementioned system, a method of scanning an industrial chemical vessel to monitor a chemical process within the industrial chemical vessel is provided, the method comprising:
positioning a first unmanned aerial vehicle (UAV) carrying a gamma radiation source on one side of the vessel;
positioning a second UAV carrying a gamma radiation detector on an opposite side of the vessel;
moving the first and second UAVs in a coordinated fashion in order to scan the vessel by passing gamma radiation through the vessel from the radiation source carried by the first UAV to the radiation detector carried by the second UAV thereby measuring a density profile of the industrial chemical vessel;
identifying a location of one or more fluid layers within the industrial chemical vessel; and
determining if a chemical process within the industrial chemical vessel is operating correctly or if there is a problem with the chemical process within the industrial chemical vessel based on the location of the one or more fluid layers within the industrial chemical vessel identified using the first and second UAVs.

While this invention has been particularly shown and described with reference to certain examples, it will be understood by those skilled in the art that various changes in form and detail may be made without departing from the scope of the invention as defined by the appended claims.

1-14. (canceled)

15. A method of scanning an industrial chemical vessel to monitor a chemical process within the industrial chemical vessel, the method comprising:
positioning a first unmanned aerial vehicle (UAV) carrying a gamma radiation source on one side of the vessel;
positioning a second UAV carrying a gamma radiation detector on an opposite side of the vessel;
moving the first and second UAVs in a coordinated fashion in order to scan the vessel by passing gamma radiation through the vessel from the radiation source carried by the first UAV to the radiation detector carried by the second UAV thereby measuring a density profile of the industrial chemical vessel;
identifying a location of one or more fluid layers within the industrial chemical vessel; and
determining if a chemical process within the industrial chemical vessel is operating correctly or if there is a problem with the chemical process within the industrial chemical vessel based on the location of the one or more fluid layers within the industrial chemical vessel identified using the first and second UAVs.

16. The method according to claim 15,
wherein the first and second UAV are controlled to maintain a fixed distance between the first and second UAV as the vessel is being scanned.

17. The method according to claim 15,
wherein the first and second UAV are controlled to locate the first UAV on one side of the vessel and the second UAV on an opposite side of the vessel and move both the first and second UAVs along the vessel in a coordinated fashion in order to measure the density profile of the vessel.

18. The method according to claim 15,
wherein the first and second UAV are controlled to locate the first UAV on one side of the vessel and the second UAV on an opposite side of the vessel and move both the first and second UAVs around the vessel in a coordinated fashion in order to generate a computed tomography (CT) scan of the vessel.

19. The method according to claim 15,
wherein each of the first and second UAVs comprises one or more sensors for measuring and controlling the UAV's distance from the vessel and height from the ground.

20. The method according to claim 15,
wherein the radiation source carried by the first UAV is disposed in a housing which at least partially shields the radiation source from its surroundings.

21. The method according to claim 19,
wherein the housing includes a collimator in order to direct a beam of radiation from the radiation source towards the radiation detector carried by the second UAV, and
the controller is configured to orientate the first UAV to direct the beam of radiation towards the radiation detector carried by the second UAV as the vessel is being scanned.

22. The method according to claim 19,
wherein the housing comprises a shutter for completely sealing the radiation source within the housing, and
a safety shut off is provided such that in the event of a malfunction the shutter is closed to completely seal the radiation source within the housing.

23. The method according to claim 15,
wherein a data processor is provided for processing radiation data from the detector.

24. The method according to claim 23,
wherein the detector comprises a data link for transmitting radiation data to the data processor.

25. The method according to claim 23,
wherein one or both of the first and second UAVs comprise a data link for transmitting location data to the data processor.

26. The method according to claim 24,
wherein the data processor is configured to synchronize the radiation data and location data to generate a scan profile.

27. The method according to claim 15,
wherein more than one UAV carrying a radiation source and/or more than one UAV carrying a radiation detector is provided, and wherein the UAVs are moved in a coordinated fashion in order to scan the vessel by passing radiation through the vessel from the radiation sources to the radiation detectors.

28. The system configured to scan an industrial chemical vessel to monitor a chemical process within the industrial chemical vessel using the method according to claim 15, the system comprising:
a first unmanned aerial vehicle (UAV) carrying a gamma radiation source;
a second UAV carrying a gamma radiation detector;
a controller configured to move the first and second UAVs in a coordinated fashion in order to scan the vessel by passing radiation through the vessel from the radiation source carried by the first UAV to the radiation detector carried by the second UAV thereby measuring a density profile of the industrial chemical vessel; and
a processing unit for identifying a location of one or more fluid layers within the industrial chemical vessel based on the density profile measurements and for determining if a chemical process within the industrial chemical vessel is operating correctly or if there is a problem with the chemical process within the industrial chemical vessel based on the location of the one or more fluid layers within the industrial chemical vessel identified using the first and second UAVs.
